(19) United States
(12) Patent Application Publication
(10) Pub. No.: US 2025/0277908 A1
(43) Pub. Date: Sep. 4, 2025

(54) LIDAR-BASED MAP GENERATION METHOD AND DEVICE THEREFOR

(71) Applicant: Seadronix Corp., Ulsan (KR)

(72) Inventors: Byeolteo PARK, Seoul (KR); Han Keun KIM, Suwon-si (KR); Dong Hoon KIM, Seoul (KR)

(21) Appl. No.: 19/212,775

(22) Filed: May 20, 2025

Related U.S. Application Data
(63) Continuation of application No. PCT/KR2023/018566, filed on Nov. 17, 2023.

(30) Foreign Application Priority Data
Nov. 25, 2022 (KR) 10-2022-0160073
Dec. 29, 2022 (KR) 10-2022-0188492

(51) Int. Cl. G01S 17/89; G01S 7/48; G01S 17/86; G06T 17/05; G06V 10/30; G06V 10/82

(52) U.S. Cl. CPC G01S 17/89; G01S 7/4802; G01S 17/86; G06T 17/05; G06V 10/30; G06V 10/82

(57) ABSTRACT

A method for map generation is proposed, and the method includes acquiring a LiDAR point cloud detected by a LiDAR sensor, selecting a vessel point cloud related to LiDAR beams reflected from a vessel from the acquired LiDAR point cloud, selecting a surrounding point cloud on the basis of a location of the selected vessel point cloud, acquiring a modified LiDAR point cloud by removing the surrounding point cloud from the LiDAR point cloud, and generating a three-dimensional map by using the modified LiDAR point cloud.

### CROSS-REFERENCE TO RELATED APPLICATIONS

This is a bypass continuation of International PCT Application No. PCT/KR2023/018566, filed on Nov. 17, 2023, which claims priority to Republic of Korea Patent Application No. 10-2022-0160073, filed on Nov. 25, 2022 and Republic of Korea Patent Application No. 10-2022-0188492, filed on Dec. 29, 2022, which are incorporated by reference herein in their entirety.

### TECHNICAL FIELD

The present disclosure relates to a method and device configured to generate a map using a LiDAR sensor at sea and, more particularly, to a method and device configured to generate a map after removing a vessel LiDAR point cloud related to LiDAR beams reflected from a vessel from an acquired LiDAR point cloud.

### BACKGROUND ART

In order to generate routes for autonomous navigation and the like of a vessel, it is required to generate a real-time map of a surrounding environment.

In general, in a case of map generation, a three-dimensional map may be generated by using a LiDAR point cloud acquired by using a LiDAR sensor.

However, in a maritime environment, there is a problem in generating a map by using a point cloud acquired by a LiDAR sensor as is.

Specifically, the LiDAR point cloud acquired by the LiDAR sensor may include LiDAR points related to LiDAR beams reflected from another vessel moving at sea. In this case, there is a problem that the accuracy of map generation is reduced because a LiDAR point cloud corresponding to another vessel is mapped together.

Meanwhile, in the maritime environment, as a vessel moves through water waves, LiDAR points related to LiDAR beams reflected from not only the vessel but also the water waves generated by the vessel are also mapped together, thereby causing a problem that the accuracy of map generation is reduced.

### SUMMARY

An objective of the present disclosure is to provide a method and device configured to generate a map by using a preprocessed LiDAR point cloud after performing preprocessing that removes a vessel point cloud, which is related to LiDAR beams reflected from a vessel, from a LiDAR point cloud acquired through a LiDAR sensor.

Another objective of the present disclosure is to provide a method and device configured to generate a map by using a preprocessed LiDAR point cloud after performing preprocessing that removes a surrounding point cloud located within a margin distance from a vessel point cloud.

The problem to be solved in the embodiment of the present disclosure is not limited to the above-described problems, and the problems not mentioned will be clearly understood by those skilled in the art to which the present disclosure belongs from the present specification and the accompanying drawings.

According to an exemplary embodiment of the present disclosure, there is provided a method for map generation, the method including: acquiring a LiDAR point cloud detected by a LiDAR sensor; selecting a vessel point cloud related to LiDAR beams reflected from a vessel from the acquired LiDAR point cloud; selecting a surrounding point cloud on the basis of a location of the selected vessel point cloud; acquiring a modified LiDAR point cloud by removing the surrounding point cloud from the LiDAR point cloud; and generating a three-dimensional map by using the modified LiDAR point cloud.

According to another exemplary embodiment of the present disclosure, there is provided a map generation device, including: a memory for storing a LiDAR mapping method and a LiDAR point cloud detected by a LiDAR sensor; and at least one processor, wherein the processor is configured to select a vessel point cloud related to LiDAR beams reflected from a vessel from the LiDAR point cloud, select a surrounding point cloud on the basis of a location of the selected vessel point cloud, acquire a modified LiDAR point cloud by removing the surrounding point cloud from the LiDAR point cloud, and generate a three-dimensional map by using the modified LiDAR point cloud.

The problem solutions of the present disclosure are not limited to the above-described solutions, and solutions that are not mentioned may be clearly understood to those skilled in the art to which the present disclosure belongs from the present specification and the accompanying drawings.

According to the present disclosure, a map is generated by using a preprocessed LiDAR point cloud after performing preprocessing that removes a vessel point cloud, which is related to LiDAR beams reflected from a vessel, from a LiDAR point cloud acquired through a LiDAR sensor, whereby the accuracy of the generated map may be increased.

According to the present disclosure, a map is generated by using a preprocessed LiDAR point cloud after performing preprocessing that removes a surrounding point cloud located within a margin distance from a vessel point cloud, whereby the accuracy of the generated map may be increased.

The effectiveness of the present disclosure are not limited to the above-described effectiveness, and effectiveness not mentioned herein may be clearly understood by those skilled in the art to which the present disclosure belongs from the present specification and the accompanying drawings.

### BRIEF DESCRIPTION OF DRAWINGS

FIG. 1 is a view illustrating a map generation system according to an exemplary embodiment.

FIG. 2 is a block diagram illustrating a configuration of a map generation device according to the exemplary embodiment.

FIG. 3 is a flowchart illustrating a method for map generation according to an exemplary embodiment.

FIG. 4 is a view illustrating a LiDAR point cloud according to the exemplary embodiment.

FIG. 5 is a view for explanation object type information generated on the basis of an image according to the exemplary embodiment.

FIGS. 6, 7, and 8 are views illustrating selection of a vessel point cloud from a LiDAR point cloud by using the object type information according to the exemplary embodiment.

FIGS. 9 and 10 are views illustrating selection of a surrounding point cloud according to the exemplary embodiment.

FIG. 11 is a view illustrating modified LiDAR points acquired from the LiDAR points.

### DETAILED DESCRIPTION

Exemplary embodiments described in the present specification are intended to clearly describe the idea of the present disclosure to those skilled in the art. Therefore, the present disclosure is not limited by the exemplary embodiments, and the scope of the present disclosure should be interpreted as encompassing modifications and variations without departing from the idea of the present disclosure.

Terms used in the present specification are selected from among general terms, which are currently widely used, in consideration of functions in the present disclosure and may have meanings varying depending on intentions of those skilled in the art, customs in the field of art, the emergence of new technologies, or the like. However, in contrast, in a case where a specific term is defined and used with an arbitrary meaning, the meaning of the term will be described separately. Accordingly, the terms used in the present specification should be interpreted on the basis of the actual meanings and the whole context throughout the present specification rather than based on just names for the terms.

The accompanying drawings are intended to easily explain the present disclosure, and shapes indicated in the drawings may be exaggerated as necessary in order to aid in understanding the present disclosure. Therefore, the present disclosure is not limited by the drawings.

When it is determined that detailed descriptions of well-known components or functions related to the present disclosure may obscure the subject matter of the present disclosure, detailed descriptions thereof may be omitted herein as necessary.

According to an exemplary embodiment of the present disclosure, there is provided a method for generating a map, the method including: acquiring a LiDAR point cloud detected by a LiDAR sensor; selecting a vessel point cloud related to LiDAR beams reflected from a vessel from the acquired LiDAR point cloud; selecting a surrounding point cloud on the basis of a location of the selected vessel point cloud; acquiring a modified LiDAR point cloud by removing the surrounding point cloud from the LiDAR point cloud; and generating a three-dimensional map by using the modified LiDAR point cloud.

The selecting of the vessel point cloud may include: acquiring an image captured by a camera module having a field of view at least partially overlapped with a field of view of the LiDAR sensor; determining a vessel area where the vessel is indicated in the image by using the image and an artificial neural network that generates object information of an object indicated in the image; and selecting a vessel point cloud from the LiDAR point cloud by considering a location of the vessel area in the image.

The location of the vessel area on the image is a location of at least one pixel among pixels corresponding to the vessel area on the image.

The selecting of the surrounding point cloud may include: calculating a width of the vessel point cloud; calculating a margin distance by multiplying a preset margin value by the width; and selecting a surrounding point cloud, which is located within the margin distance from the vessel point cloud, from the LiDAR point cloud.

The selecting the surrounding point cloud may include: determining a center position of the vessel point cloud; calculating the width of the vessel point cloud; calculating the margin distance by multiplying the width by the preset margin value; and selecting the surrounding LiDAR point cloud, which is located within the margin distance from the center position, from the LiDAR point cloud.

According to another exemplary embodiment of the present disclosure, there may be provided a map generation device, including: a memory for storing a LiDAR mapping method and a LiDAR point cloud detected by a LiDAR sensor; and at least one processor, wherein the processor is configured to select a vessel point cloud related to LiDAR beams, which are reflected from a vessel, from a LiDAR point cloud, select a surrounding point cloud on the basis of a location of the selected vessel point cloud, acquire a modified LiDAR point cloud by removing the surrounding point cloud from the LiDAR point cloud, and generate a three-dimensional map by using the modified LiDAR point cloud.

The memory may store an image acquired by a camera module having a field of view at least partially overlapped with a field of view of the LiDAR sensor and an artificial neural network that generates object information of an object indicated in the image, and the processor may determine a vessel area where the vessel is indicated on the image by using the image and the artificial neural network, and select the vessel point cloud from the LiDAR point cloud by considering the location of the vessel area on the image.

The location of the vessel area on the image is a location of at least one pixel among pixels corresponding to the vessel area on the image.

The memory may store the preset margin value, and the processor may calculate the width of the vessel point cloud, calculate the margin distance by multiplying the width by the preset margin value, and select the surrounding point cloud, which is located within the margin distance from the vessel point cloud, from the LiDAR point cloud.

The memory may store the preset margin value, and the processor may determine the center position of the vessel point cloud, calculate the width of the vessel point cloud, calculate the margin distance by multiplying the width by the preset margin value, and select the surrounding LiDAR point cloud, which is located within the margin distance from the center position, from the LiDAR point cloud.

Below, a method for map generation and a device therefor according to the exemplary embodiments are described.

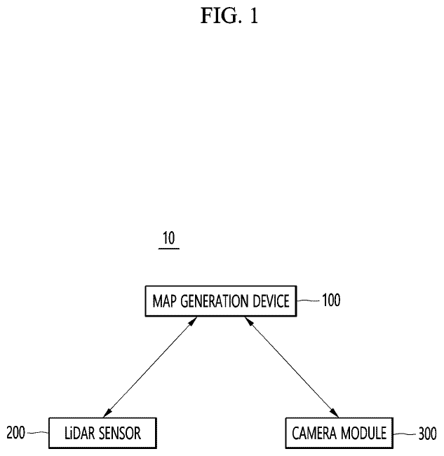

FIG. 1 is a view illustrating a map generation system 10 according to an exemplary embodiment.

The map generation system 10 according to the exemplary embodiment may generate a three-dimensional map and/or a two-dimensional map, which are highly accurate, by using a LiDAR point cloud acquired from a LiDAR sensor and an image acquired from a camera module.

Specifically, the map generation system 10 may select a vessel point cloud, which is related to LiDAR beams reflected from a vessel, from the LiDAR point cloud by using an image acquired from the camera module whose field of view is at least partially overlapped with that of the LiDAR sensor, and select a surrounding point cloud on the basis of a location of the vessel point cloud. The map generation system 10 may acquire a modified LiDAR point cloud excluding the surrounding point cloud from the LiDAR point cloud, and generate a three-dimensional map by using the acquired modified LiDAR point cloud.

The three-dimensional map generated according to the method disclosed by the present application is generated by the modified point cloud in which both a vessel LiDAR point cloud reflected from a vessel causing noise in the map generation and a surrounding point cloud reflected from water waves generated by the vessel has been removed, and thus, the accuracy may be higher than that of generating a three-dimensional map using the initially acquired LiDAR point cloud. For example, the three-dimensional map generated according to the method disclosed by the present application may indicate fixed terrain or an object, but may not indicate a moving object temporarily detected or water waves generated by the object moving on a sea surface.

Meanwhile, a two-dimensional map may be generated by reducing the dimension of the generated three-dimensional map. Since the three-dimensional map with high accuracy is used, the generated two-dimensional map may also have high accuracy.

More specifically, referring to FIG. 1, the map generation system 10 may include a map generation device 100, a LiDAR sensor 200, and a camera module 300.

According to the exemplary embodiment, the LiDAR sensor 200 and the camera module 300 may be arranged in a port or a vessel, so as to detect or capture surrounding objects or the sea. In this case, the field of view of the LiDAR sensor 200 may be at least partially overlapped with the field of view of the camera module 300. Meanwhile, according to the exemplary embodiment, the map generation system 10 may include a plurality of LiDAR sensors 200 and may include a plurality of camera modules 300.

According to the exemplary embodiment, the map generation device 100 may acquire a LiDAR point cloud through the LiDAR sensor 200 and acquire an image through the camera module 300. The map generation device 100 may generate a map by using the acquired data. A specific method for map generation will be described later.

The map generation device 100 may be arranged on a vessel. However, this is not limited thereto, and the map generation device 100 may also be arranged on a port facility such as a control center.

The map generation device 100 may be used in determining a navigation route. The map generation device 100 may transmit the generated map to a device for determining the navigation route.

For example, in a case where the map generation device 100 is installed on a vessel and the device for determining the navigation route is installed on the vessel as well, a generated map may be transmitted from the map generation device 100 to the device for determining the navigation route installed on the vessel.

For another example, in a case where the map generation device 100 is installed outside a vessel (e.g., the port facility, the control center, etc.) and the device for determining the navigation route is installed on the vessel, a generated map may be transmitted from the port facility or control center to the vessel.

For a yet another example, in a case where both the map generation device 100 and the device for determining the navigation route are installed outside a vessel, the map generation device 100 transmits a generated map to the device for determining the navigation route, and a navigation route determined by the device for determining the navigation route may be ultimately transmitted to the vessel.

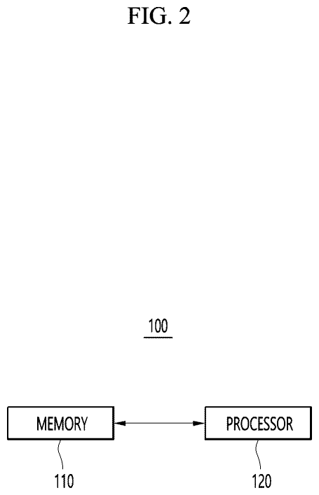

FIG. 2 is a block diagram illustrating a configuration of a map generation device 100 according to the exemplary embodiment.

Referring to FIG. 2, the map generation device 100 may include a memory 110 and a processor 120.

The memory 110 may store various processing programs, parameters for processing the programs, result data of such processing, and the like. For example, the memory 110 may store instructions, a method for generating object type information, information on the location and angle of an installed LiDAR sensor, information on the location and angle of an installed camera module, a LiDAR mapping method, and the like for the operation of the processor 120 to be described below.

The memory 110 may store LiDAR point cloud data and image data, which are acquired from the outside. The LiDAR point cloud data may be data acquired from the LiDAR sensor 200, and the image data may be data acquired from the camera module 300.

The memory 110 may be implemented with a non-volatile semiconductor memory, a hard disk, a flash memory, a random-access memory (RAM), a read-only memory (ROM), an electrically erasable programmable read-only memory (EEPROM), other types of tangible non-volatile recording media, or the like.

The processor 120 may operate according to an instruction stored in the memory 110, and may select a vessel LiDAR point from a LiDAR point cloud by using an image. The processor 120 may select surrounding LiDAR points on the basis of the location of the vessel LiDAR point, and may acquire modified LiDAR points by removing a surrounding LiDAR point cloud from the LiDAR point cloud. The processor 120 may generate a three-dimensional map by using the modified LiDAR points and the LiDAR mapping method, and may also generate a two-dimensional map by reducing the dimension of the generated three-dimensional map.

The various operations or steps of map generation disclosed in the exemplary embodiment of the present disclosure below may be interpreted as being performed by the processor 120 of the map generation device 100 or being performed under the control of the processor 120 unless otherwise stated. The specific operation method of the processor 120 will be described later.

Meanwhile, the processor 120 may be implemented with a central processing unit (CPU), a graphics processing unit (GPU), a digital signal processor (DSP), a state machine, an application-specific integrated circuit (ASIC), a radio-frequency integrated circuit (RFIC), a combination thereof, and the like.

Below, a method for map generation according to the exemplary embodiment is described.

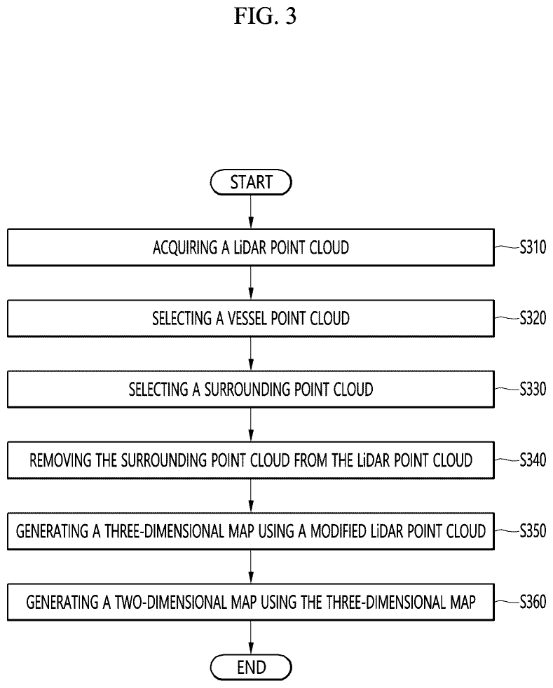

FIG. 3 is a flowchart illustrating a method for map generation according to the exemplary embodiment.

Referring to FIG. 3, the method for the map generation according to the exemplary embodiment of the present disclosure includes processes as follows: step S310 of acquiring a LiDAR point cloud, step S320 of selecting a vessel point cloud from the LiDAR point cloud, step S330 of selecting a surrounding point cloud on the basis of a location of the vessel point cloud, step S340 of removing the surrounding point cloud from the LiDAR point cloud, step S350 of generating a three-dimensional map by using modified LiDAR points, and step S360 of generating a two-dimensional map by using the three-dimensional map.

The LiDAR point cloud may be acquired by a LiDAR sensor. The LiDAR sensor is a sensor installed in a port or a vessel, so as to detect surrounding objects or the sea.

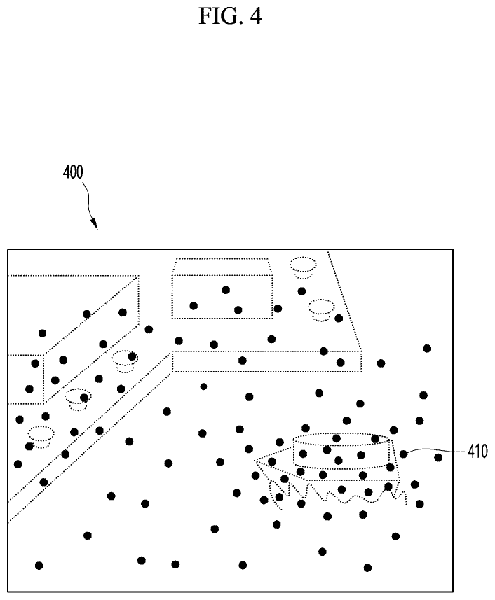

FIG. 4 is a view illustrating a LiDAR point cloud according to the exemplary embodiment.

FIG. 4 illustrates the LiDAR point cloud as a two-dimensional view, but the LiDAR point cloud may mean three-dimensional data. The images of a port and a vessel, which are indicated by dotted lines in FIG. 4, are intended to help understand FIG. 4, and the LiDAR point cloud may exist separately from the images.

Referring to FIG. 4, the acquired LiDAR point cloud 400 is generated by LiDAR beams reflected from each object located within a field of view (FOV). Each point cloud has the corresponding information related to a position (e.g., a distance from the LiDAR sensor and an angle within the corresponding field of view), and accordingly, each point cloud may be displayed in a three-dimensional coordinate system.

Among the objects, objects including not only port types, port facilities, and sea structures, which are required for map generation, but also a vessel, water waves generated by the vessel, or the like, which cause noise in the map generation may exist. Accordingly, when the vessel, the water waves generated by the vessel, or the like are located within the field of view of the LiDAR sensor, LiDAR beams may be reflected by the vessel or the water waves generated by the vessel. That is, a LiDAR point cloud may be generated by the vessel or the water waves generated by the vessel. The vessel, the water waves generated by the vessel, or the like, which cause the noise in the map generation, is also indicated to a three-dimensional map when the three-dimensional map is generated by using all the point clouds acquired by the LiDAR sensor, so it is required to selectively remove a point cloud generated by the vessel or the water waves generated by the vessel.

Meanwhile, referring to FIG. 4, as described above, it is required to selectively remove point clouds corresponding to a vessel and water waves generated by the vessel, but there is a practical problem in that it is difficult to determine from which object each area is reflected by using an acquired LiDAR point cloud 400 itself. Accordingly, a special method has to be introduced in order to select the point clouds corresponding to the vessel and the water waves generated by the vessel.

In the method disclosed by the present application, in order to select point clouds corresponding to a vessel and water waves generated by the vessel, there is proposed a method for selecting a vessel point cloud, which is a LiDAR point cloud related to LiDAR beams reflected from the vessel by using an image acquired from the camera module whose field of view is at least partially overlapped with that of a LiDAR sensor.

Below, a method for selecting a vessel point cloud from a LiDAR point cloud is described in more detail.

According to the exemplary embodiment, the vessel point cloud may be selected from the LiDAR point cloud by using object type information. The object type information may be generated on the basis of an image. The object type information may indicate information about the types of objects included in the image. The object type information may include data corresponding to an object indicated in the image and pointing to the object. The object type information may be indicated in the image by considering the location of the object indicated in the image within the image.

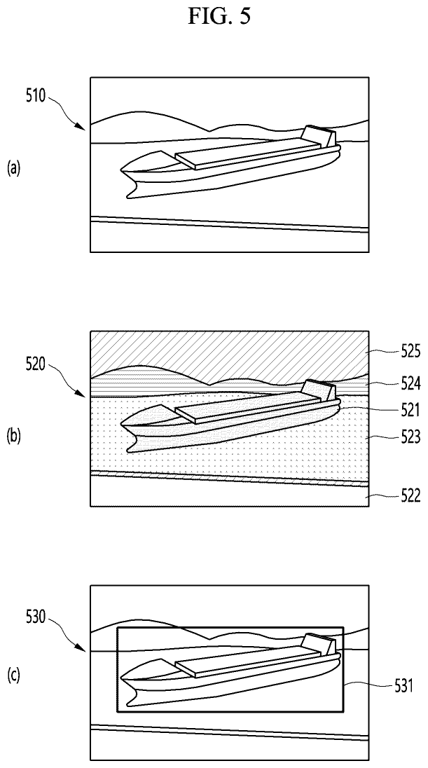

FIG. 5 is a view for explantion object type information generated on the basis of an image according to the exemplary embodiment.

FIG. 5(a) shows an image 510 captured by a camera module, FIG. 5(b) shows a segmentation image 520 that is the visualized segmentation information and an example of object type information generated on the basis of the image 510, and FIG. 5(c) shows a detection image 530 that is the visualized detection information and another example of the object type information generated on the basis of the image 510.

According to the exemplary embodiment, the map generation device may generate the segmentation information on the basis of the image 510. The segmentation information may include a plurality of segmentation data. The plurality of segmentation data may respectively correspond to pixels of the frame of the image 510. Each piece of the plurality of segmentation data may indicate a type of object represented by a corresponding pixel. Accordingly, the segmentation information may indicate a location of an object within the image 510 where the object is indicated. The segmentation information may include at least one of segmentation data corresponding to a vessel, segmentation data corresponding to a quay wall, segmentation data corresponding to the sea or a sea surface, segmentation data corresponding to terrain, and segmentation data corresponding to the sky.

Segmentation information may be visualized. For example, the segmentation information may be visualized in the form of a segmentation image 520, which is expressed so as to be distinct in separate colors and the like according to the object types indicated by the plurality of segmentation data. In this case, referring to FIG. 5(b), the segmentation image 520 may indicate an area 521 corresponding to a vessel, an area 522 corresponding to a quay wall, an area 523 corresponding to the sea or a sea surface, an area 524 corresponding to terrain, and an area 525 corresponding to the sky.

According to another exemplary embodiment, the map generation device may generate detection information on the basis of an image 510. The detection information may include one or more detection data. Each piece of detection data may correspond to an object indicated in the image 510. Each detection data may indicate the type of object it corresponds to. Each piece of detection data may indicate a location of the corresponding object within the image 510. The detection information may include at least one of detection data corresponding to a vessel, detection data corresponding to a quay wall, detection data corresponding to the sea or a sea surface, detection data corresponding to terrain, and detection data corresponding to the sky.

Detection information may be visualized. For example, the detection information may be visualized in the form of a detection image 530, in which a location of an object indicated by detection data within the image 510 is expressed in the form of a bounding box. Referring to FIG. 5(c), in the detection image 530, the detection information 531 corresponding to the vessel may be expressed at the location of the vessel indicated in the image 510.

The map generation device may generate object type information by using an artificial neural network. Examples of the artificial neural network include, but are not limited to, a Convolution Neural Network (CNN), a You Only Look Once (YOLO) system, a Single Shot MultiBox Detector (SSD), etc. The artificial neural network may be trained through various methods such as supervised learning, unsupervised learning, reinforcement learning, imitation learning, etc. In addition, the map generation device does not necessarily have to generate the object type information by using the artificial neural network, and may also generate object type information by using other methods.

The map generation device may identify the types of objects corresponding to one or more LiDAR points included in a LiDAR point cloud by using the object type information. For example, the map generation device projects the LiDAR point cloud onto an image plane, and determines what type of object a point where each of one or more LiDAR points included in the LiDAR point cloud is projected onto the image plane corresponds to by using the object type information, thereby identifying the type of object corresponding to each of the LiDAR points.

The map generation device may determine one or more vessel points from the LiDAR point cloud on the basis of the identified results. In the present specification, the vessel points or a vessel point cloud refer to a point cloud, which is generated by reflection by a vessel, among LiDAR point clouds. The map generation device may select one or more LiDAR points identified as corresponding to a vessel from the LiDAR point cloud as one or more vessel points by using segmentation results and the like for an image generated by the camera module. The selected vessel points may form the vessel point cloud.

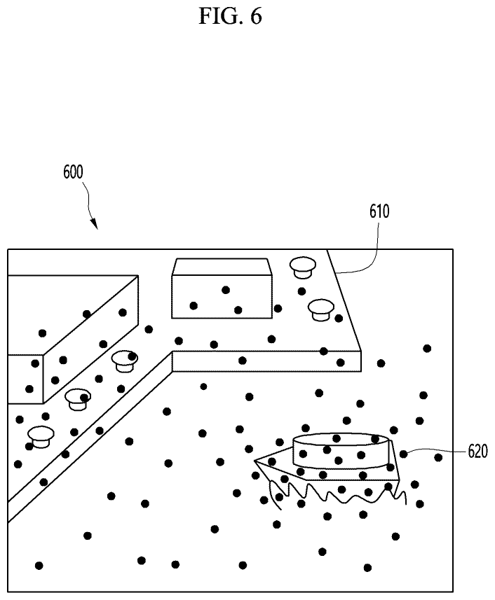

FIGS. 6, 7, and 8 are views illustrating selection of a vessel point cloud from the LiDAR point cloud by using the object type information according to the exemplary embodiment.

Referring to FIG. 6, the map generation device may project the acquired LiDAR point cloud 410 illustrated in FIG. 4 onto an image plane 600 on which an image 610 is indicated. Accordingly, the map generation device may acquire a projected LiDAR point cloud 620. In this case, a view point at which the image is acquired from the camera module may be the same as a view point at which the LiDAR point cloud is acquired from the LiDAR sensor.

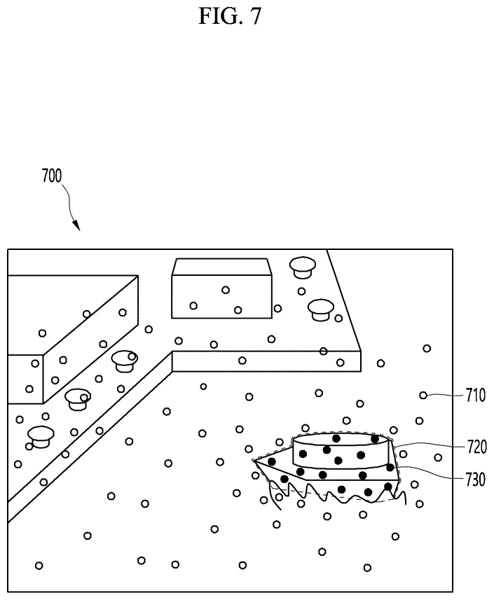

Referring to FIG. 7, the map generation device may select a vessel point cloud 730 from a projected LiDAR point cloud 710 by using segmentation information.

Specifically, the map generation device may acquire segmentation information by performing image segmentation on the image 610, and may identify the type of object corresponding to the LiDAR point cloud 710 by using the acquired segmentation information. The map generation device may select LiDAR points corresponding to the vessel as the vessel point cloud 730 on the basis of the identified results.

Meanwhile, the map generation device may determine a location 720 where the vessel is indicated on an image plane 700 by using the segmentation information, and may also select, as the vessel point cloud 730, the LiDAR points corresponding to the location 720 where the vessel is indicated.

Meanwhile, the map generation device may select LiDAR points corresponding to not only another vessel but also the vessel in question as a vessel point cloud.

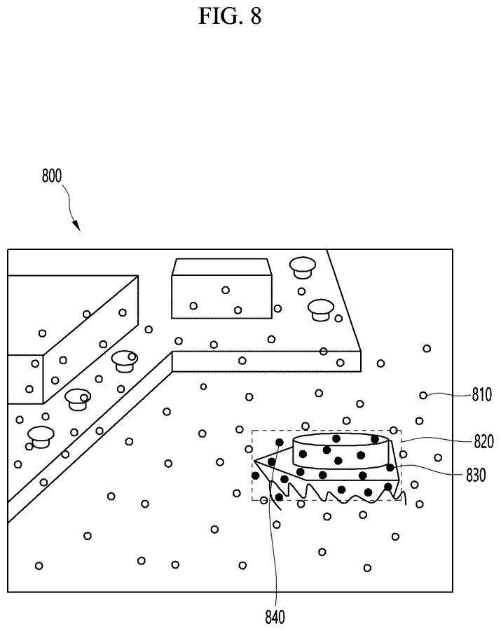

Referring to FIG. 8, the map generation device may select a vessel point cloud 830 from a projected LiDAR point cloud 810 by using detection information.

Specifically, the map generation device may acquire detection information by performing object detection on the image 610, and may identify the type of object corresponding to the LiDAR point cloud 810 by using the acquired detection information. The map generation device may select LiDAR points corresponding to the vessel as the vessel point cloud 830 on the basis of the identified results.

Meanwhile, the map generation device may determine a location 820 where the vessel is indicated on an image plane 800 by using the detection information, and may also select, as the vessel point cloud 830, a LiDAR point corresponding to the location 820 where the vessel is indicated.

Meanwhile, the map generation device may select LiDAR points corresponding to not only another vessel but also the vessel in question as a vessel point cloud.

When the exemplary embodiment using the detection information in FIG. 8 is compared with the exemplary embodiment using the segmentation information in FIG. 7, the segmentation information distinguishes objects included in the image by pixel, whereas the detection information distinguishes the objects in the form of bounding box, so that even a LiDAR point 840 that does not actually correspond to an object may be selected as an object LiDAR point. Accordingly, the map generation device may select a vessel point cloud more accurately by using the segmentation information than by using the detection information.

Meanwhile, the map generation device may also select a vessel point cloud by dimensionally expanding an image into three dimensions.

Specifically, the map generation device may generate object type information on the basis of an image, and determine a vessel area in which a vessel is indicated on the image by using the object type information.

The map generation device may determine a three-dimensional vessel space corresponding to the determined vessel area after dimensionally expanding the image into the three dimensions. The dimensional expansion may be performed along a direction of the field of view of the camera module. The dimensionally expanded image may be at least partially overlapped with the three-dimensional space where the LiDAR point cloud is located.

The map generation device may select, as the vessel point cloud, the LiDAR point cloud located within the determined vessel space.

Meanwhile, the map generation device may use information on a location and angle at which the camera module is installed, information on a location and angle at which the LiDAR sensor is installed, and information on relative locations and angles of the camera module and the LiDAR sensor in order to determine an overlapping field of view between the LiDAR sensor and the camera module, or determine an overlapping three-dimensional space between the dimensionally expanded image and the LiDAR point cloud.

The map generation device may select a surrounding point cloud on the basis of the location of the selected vessel point cloud. The selected surrounding point cloud may include the vessel point cloud.

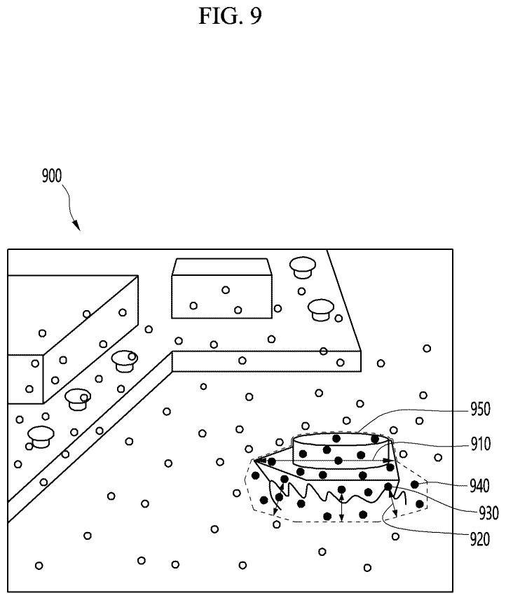

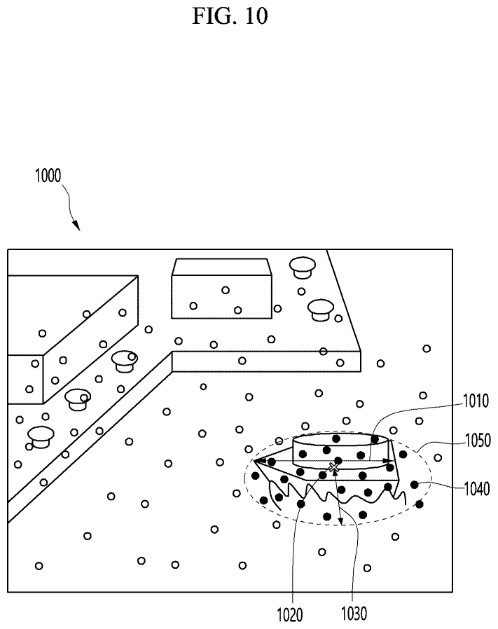

FIGS. 9 and 10 are views illustrating selection of a surrounding point cloud according to the exemplary embodiment.

FIGS. 9 and 10 are views each illustrating planes 900 and 1000 indicated together with respective images, but this is for the purpose of helping understanding, and actually, the LiDAR point cloud may be arranged on a three-dimensional space in which these images are not indicated. In addition, a vessel point cloud and a surrounding point cloud may be identified only with three-dimensional LiDAR point clouds without image projection.

Referring to an exemplary embodiment in FIG. 9, a map generation device may calculate a width 910 of the vessel point cloud in order to select a surrounding point cloud 950. The width 910 may mean a three-dimensional width of the vessel point cloud. The width 910 may mean the longest width of the vessel point cloud, but is not limited thereto, and may also mean an average or other statistical value of widths.

The map generation device may calculate a first margin distance 920 by multiplying the calculated width 910 by a preset first value. For example, the first value may be set to 0.2 to 0.3, but is not limited to such a range described.

The map generation device may select, as surrounding points 940, LiDAR points located within the first margin distance 920 from each point 930 of the vessel point cloud. The selected surrounding points 940 may form the surrounding point cloud 950. That is, from the LiDAR point cloud, the map generation device may select a LiDAR point cloud, which is located within the first margin distance 920 from the vessel point cloud, as the surrounding point cloud 950.

In relation to FIG. 9, points located above the area where the vessel is indicated in the view may also appear to be located within the first margin distance 920 from the vessel points 930. However, this is due to the fact that FIG. 9 is displayed in two dimensions. In three dimensions, the points located above the area where the vessel is indicated may be points located further out at sea than the first margin distance 920 from the vessel points 930. Accordingly, the points located above the area where the vessel is indicated in FIG. 9 are not selected as the surrounding points 940 because the points are not located within the first margin distance 920 from the vessel points 930.

Referring to another exemplary embodiment in FIG. 10, the map generation device may further determine a center 1020 of a vessel point cloud. The center 1020 may mean the center of the vessel point cloud in a three-dimensional space.

The map generation device may calculate a second margin distance 1030 by multiplying a calculated width 1010 by a preset second value. For example, this second value may be set to 0.7 to 0.8, but is not limited to such a range described.

The map generation device may select, as surrounding points 1040, LiDAR points located within the second margin distance 1030 from the center 1020 of the vessel point cloud. The selected surrounding points may form a surrounding point cloud 1050. That is, from the LiDAR point cloud, the map generation device may select a LiDAR point cloud, which is located within the second margin distance 1030 from the center 1020 of the vessel point cloud, as the surrounding point cloud 1050.

Meanwhile, the map generation device may select an arbitrary point other than the center of the vessel point cloud in the three-dimensional space in order to select the surrounding points 1040. The arbitrary one point may be, but is not limited to, a center of a point cloud corresponding to the bow of the vessel or to a center of the point cloud corresponding to the stern of the vessel.

In relation to FIG. 10, the points located above the area where the vessel is indicated in the view may also appear to be located within the second margin distance 1030 from the center 1020. However, this is due to the fact that FIG. 10 is displayed in two dimensions. In the three-dimensional space, the points located above the area where the vessel is indicated may be points located further out at sea than the second margin distance 1030 from the center 1020. Accordingly, the points located above the area where the vessel is indicated in FIG. 10 are not selected as the surrounding points 1040 because the points are not located within the second margin distance 1030 from the center 1020.

Meanwhile, the map generation device may also utilize not only a width of the vessel point cloud but also a depth and/or height of the vessel point cloud in order to derive the margin distance.

Specifically, the map generation device may calculate the margin distance by way of multiplying at least one or a combination of the width, depth, and height by a preset value.

Here, the depth may mean a difference between a distance to the closest vessel point and a distance to the farthest vessel point in the vessel point cloud.

Here, the height may mean a height of the vessel point cloud in the three-dimensional space. The height may mean, but is not limited to, the highest height in the vessel point cloud, and may also mean an average or other statistical value of heights.

Here, the preset value may be the first value or the second value, and may also be different from the first value and the second value depending on which of the width, depth, and height is used in order to calculate the margin distance or depending on which method is used in order to select the surrounding point cloud.

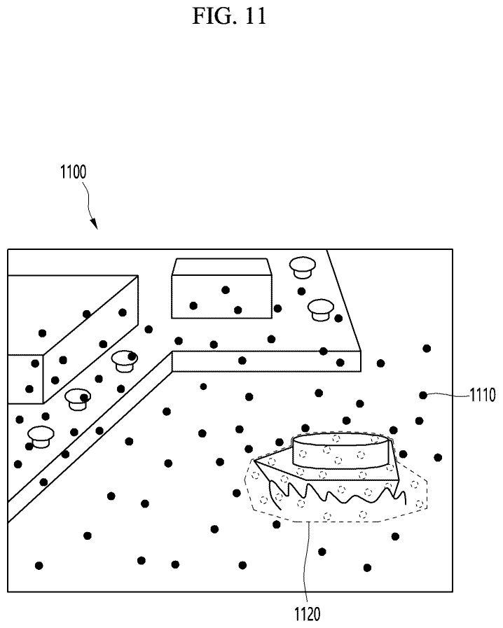

FIG. 11 is a view illustrating modified LiDAR points acquired from LiDAR points.

Referring to FIG. 11, the map generation device may acquire a modified LiDAR point cloud 1110 by controlling a surrounding point cloud 1120 selected from a LiDAR point cloud.

Specifically, the map generation device may select a surrounding point cloud for a wider range than an area occupied by an actual vessel, and remove the surrounding point cloud from the LiDAR point cloud, so as to acquire the modified LiDAR point cloud. Accordingly, in the modified LiDAR point cloud, not only a LiDAR point cloud related to LiDAR beams reflected from a vessel, but also a LiDAR point cloud related to LiDAR beams reflected from water waves generated by the vessel may also be removed together. That is, the modified LiDAR point cloud may be LiDAR points having noise removed.

The map generation device may generate a three-dimensional map by using the modified LiDAR points. In order to generate the three-dimensional map by using the LiDAR point cloud, the map generation device may use a LiDAR Odometry And Mapping (LOAM) algorithm or a Continuous Time-Iterative Closest Point (CT-ICP) algorithm, but is not limited thereto, and may use various types of algorithms in order to generate the three-dimensional map.

The map generation device uses the modified LiDAR points having the noise removed in order to generate the three-dimensional map, so that a highly accurate three-dimensional map may be generated.

Meanwhile, the map generation device may also acquire an additionally modified point cloud by further applying a patchwork algorithm to the modified point cloud. In this case, the additionally modified point cloud may be in a condition where noise due to a sea surface is also removed. Accordingly, in a case where the map generation device generates a three-dimensional map by using the additionally modified point cloud, the accuracy of the map may be further improved.

The map generation device may also generate a two-dimensional map by reducing the generated three-dimensional map into two dimensions.

The two-dimensional map is generated by using the high-accuracy three-dimensional map, so the generated two-dimensional map may also be highly accurate. Accordingly, there is effectiveness of being able to use the highly accurate two-dimensional map in generating routes for vessel operation.

The methods according to the exemplary embodiments may be implemented in the form of program instructions that may be executed through various computer means, and may be recorded in a computer-readable medium. The computer-readable medium may include program instructions, data files, data structures, and the like alone or in combination thereof. The program instructions recorded on the medium may be designed and configured specifically for the exemplary embodiments or may be publicly known and available to those skilled in the art regarding computer software. Examples of the computer-readable recording medium include: a magnetic medium such as a hard disk, a floppy disk, and a magnetic tape; an optical medium such as a CD-ROM, a DVD; a magneto-optical medium such as a floptical disk; and a hardware device specially configured to store and perform program instructions, the hardware device including a read-only memory (ROM), a random access memory (RAM), a flash memory, etc. Examples of the computer instructions include not only machine language code generated by a compiler, but also high-level language code executable by a computer using an interpreter or the like. The hardware device described above may be configured so as to be operated by one or more software modules in order to perform the operations of the exemplary embodiments, and vice versa.

The present disclosure described above is capable of various substitutions, modifications, and changes without departing from a scope of the technical idea of the present disclosure for those skilled in the art to which the present disclosure pertains, so the present disclosure is not limited by the above-described exemplary embodiments and attached drawings. In addition, the exemplary embodiments described in the present document are not intended to be limited in application, but all or part of each of the exemplary embodiments may also be selectively combined and configured so that various modifications may be made. Furthermore, the steps constituting each exemplary embodiment may be used individually or in combination with the steps constituting other exemplary embodiments.

What is claimed is:

1. A method for map generation, comprising:
acquiring a Light Detection and Ranging (LiDAR) point cloud detected by a LiDAR sensor;
acquiring a first image captured by a camera module having a field of view that is at least partially overlapped with a field of view of the LiDAR sensor;
selecting a vessel point cloud related to LiDAR beams reflected from a vessel among the acquired LiDAR point cloud using the first image;
calculating a width of the vessel point cloud;
calculating a margin distance by multiplying a predetermined margin value by the width;
selecting an interference point cloud including the vessel point cloud and LiDAR points located within the margin distance from LiDAR points of the vessel point cloud among the LiDAR point cloud to remove water waves generated by a movement of the vessel;
obtaining a modified LiDAR point cloud by removing the interference point cloud from the LiDAR point cloud; and
generating a three-dimensional map using the modified LiDAR point cloud.

2. The method of claim 1, wherein the selecting of the vessel point cloud comprises:
determining a vessel area reflected the vessel in the first image using an artificial neural network that calculates object information of object reflected in an input image and the first image; and
selecting the vessel point cloud among the LiDAR point cloud considering a position of the vessel area in the first image.

3. The method of claim 2, wherein the position of the vessel area in the first image is a position of at least one pixel among pixels corresponding to the vessel area in the first image.

4. A map generation device, comprising:
a LiDAR sensor;
a camera module having a field of view is at least partially overlapped with a field of view of the LiDAR sensor;
a memory storing a LiDAR point cloud detected by the LiDAR sensor, a first image captured by the camera module, a predetermined margin value, and a LiDAR mapping method; and
at least one processor, wherein the processor:
selects a vessel point cloud related to LiDAR beams reflected from a vessel among the LiDAR point cloud using the first image,
calculates a width of the vessel point cloud,
calculates a margin distance by multiplying the margin value by the width,
selects an interference point cloud including the vessel point cloud and LiDAR points located within the margin distance from LiDAR points of the vessel point cloud among the LiDAR point cloud to remove water waves generated by a movement of the vessel,
obtains a modified LiDAR point cloud by removing the interference point cloud from the LiDAR point cloud, and
generates a three-dimensional map using the modified LiDAR point cloud.

5. The map generation device of claim 4,
wherein the memory stores an artificial neural network that calculates object information of object reflected in an input image; and
wherein the processor determines a vessel area reflected the vessel in the first image using the artificial neural network and the first image, and selects the vessel point cloud among the LiDAR point cloud considering a position of the vessel area in the first image.

6. The map generation device of claim 5, wherein the position of the vessel area in the first image is a position of at least one pixel among pixels corresponding to the vessel area in the first image.

7. A computer-readable non-transitory storing instructions thereon, the instructions when executed by one or more processors cause the one or more processors to generate a map by:
acquiring a Light Detection and Randing (LiDAR) point cloud detected by a LiDAR sensor;
acquiring a first image captured by a camera module having a field of view that is at least partially overlapped with a field of view of the LiDAR sensor;
selecting a vessel point cloud related to LiDAR beams reflected from a vessel among the acquired LiDAR point cloud using the first image;
calculating a width of the vessel point cloud;
calculating a margin distance by multiplying a predetermined margin value by the width;
selecting an interference point cloud including the vessel point cloud and LiDAR points located within the margin distance from LiDAR points of the vessel point cloud among the LiDAR point cloud to remove water waves generated by a movement of the vessel;
obtaining a modified LiDAR point cloud by removing the interference point cloud from the LiDAR point cloud; and
generating a three-dimensional map using the modified LiDAR point cloud.
